(19) United States
(12) Patent Application Publication
(10) Pub. No.: US 2013/0191310 A1
(43) Pub. Date: Jul. 25, 2013

(54) PREDICTION MODEL REFINEMENT FOR INFORMATION RETRIEVAL SYSTEM

(71) Applicant: Ahmed Hassan Awadallah, Redmond, WA (US)

(72) Inventor: Ahmed Hassan Awadallah, Redmond, WA (US)

(73) Assignee: Microsoft Corporation, Redmond, WA (US)

(21) Appl. No.: 13/355,576

(22) Filed: Jan. 23, 2012

(51) Int. Cl. G06F 15/18

(52) U.S. Cl. 706/12

(57) ABSTRACT

A learning system refines a prediction model that determines the effectiveness of a search engine in achieving a goal of a search. Search goal achievements are estimated for sequences of user actions in an unlabeled data set using the prediction model, which is based on a mixture model and values for parameters of the mixture model. The values of the parameters are redefined based at least on the search goal achievement estimates of the unlabeled set. The prediction model is stored in accordance with the mixture model and the redefined values.

### BACKGROUND

Information retrieval systems, which are more commonly known as web search engines, are designed to enable a search for information on the Internet or World Wide Web. When a user enters a query or a search term into the search engine, search results are generally presented in a list, which is often referred to as a search engine results page. The results in the list may include information such as web pages, images, videos, news, and other types of files, for example.

Search engines commonly use ranking functions to determine an order in which information is presented in response to a received query. Further, in order to provide optimized search results, functions have also been developed that rank query concepts and keywords, that categorize query types, and that evaluate the search engine.

Traditionally, per-query metrics, such as, for example, Mean Average Precision, Precision @k, and Normalized Discounted Cumulative Gain (NDCG), have been used as functions for evaluating effectiveness of a search engine. It has also been proposed to perform search engine evaluation using behavioral signals, at both a query level and a search goal level. At the query level, the search engine evaluation is performed with respect to a single query. However, at the search goal level, the search engine evaluation is performed with respect to information sought by the user, which may involve more than one query.

Known data can be utilized to train the above described functions or metrics. Specifically, the known data trains the function so that it provides more accurate results when the function is performed. When the known data is used for training, it is commonly referred to as training data. There are two types of training data; namely, labeled data and unlabeled data. Each piece of labeled data has been categorized as providing a specific type of result for which the function is being trained. Unlabeled data, however, is a set of data without any categorization relating the data to the desired function. For example, when training a search engine evaluation function, a piece of labeled data is typically a series of user actions with respect to a search that was previously categorized as “success” or “failure” with respect to achieving a given search goal. A piece of unlabeled data may be a series of user actions with respect to a search that remains uncategorized with respect to achieving a given search goal. Genefally, the amount of available unlabeled data is significantly greater than the amount of available labeled data. Due to this difference in availability, unlabeled data can generally be acquired at a lower cost than labeled data.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A prediction model predicts the effectiveness of a search engine in achieving a goal of a search, and may be refined by a learning system. A mixture model correlates a sequence of user actions and search goal achievement, with respect to the search engine. Search goal achievements are estimated for sequences of user actions in an unlabeled data set using the prediction model, which is based on the mixture model and values for parameters of the mixture model. The values of the parameters are redefined based at least on the search goal achievement estimates of the unlabeled set. The prediction model is stored in accordance with the mixture model and the redefined values.

The estimating of search goal achievements for sequences of user actions in an unlabeled data set and the redefining of the values of the parameters may be repeated for refinement of the prediction model, while the redefined values continue to improve. The prediction model may be stored in accordance with the mixture model and the redefined values, after improvement of the redefined values ceases.

Many of the attendant features will be more readily appreciated as the same become better understood by reference to the following detailed description considered in connection with the accompanying drawings.

### DESCRIPTION OF THE DRAWINGS

The above and other aspects, features and advantages of the present invention will be more apparent from the following description when taken in conjunction with the accompanying drawings, in which:

FIG. 1 is a diagram illustrating a system for prediction model generation and refinement.

FIG. 2 is a flow diagram illustrating a prediction model refinement methodology.

FIG. 3 is a flow diagram illustrating a mixture model generation methodology.

FIG. 4 is a graph comparing the accuracies of a prediction model that uses labeled data and a prediction model that uses both labeled data and unlabeled data.

FIG. 5 is a block diagram of an illustrative hardware implementation of a computing system.

### DETAILED DESCRIPTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

The terms and words used in the following description and claims are not limited to their dictionary meanings, but are merely used to enable a clear and consistent understanding of the invention. Accordingly, it should be apparent to those skilled in the art that the following description of embodiments of the present invention is provided for illustrative purposes only and not for the purpose of limiting the invention, as defined by the appended claims and their equivalents.

It is to be understood that the singular forms “a,” “an,” and “the” include plural referents unless the context clearly dictates otherwise. Thus, for example, reference to “an identifier” includes reference to one or more of such identifiers.

During an Internet or web search, when queries are submitted to a search engine, the search engine returns a search results page for each query. A user that submitted the query may interact with the search results page in order to achieve a search goal. In accordance with embodiments of the present invention, the search goal is a single piece of information sought by the user.

The user submits one or more queries and interacts with the search results page in an effort to obtain the search goal. Thus, every search goal has a corresponding ordered sequence of user actions. This sequence of user actions is also referred to herein as a search trail. The user actions are all types of actions that may be performed by the user with respect to the search engine. The user actions include, for example, a query submission, a query rewrite, a query result selection, a search engine sponsored result selection, and the selection of any other search engine feature. The search trail also defines the time between consecutive user actions, which provides an estimate of an amount of time the user views or considers a given piece of information resulting from a previous user action.

For example, if a goal of a user's search is the name of an actor in specific movie, the user may first submit a search query to a search engine that includes the name of the movie. If the name of the actor is not provided in the search results page, the user may refine the query so that it includes the name of the movie and the term “cast”. Thus, an initial search, a refinement of the search, and a selection of search results may be performed as user actions before the search goal is successfully achieved, or the user ceases the search. This sequence of user actions is the search trail for the user's search goal.

Accordingly, embodiments of the present invention provide a learning model, or diagnostic tool, that predicts effectiveness of a search engine in achieving a goal of a search. More specifically, embodiments of the present invention relate to the refinement of a model that predicts whether a search goal was achieved using the search engine, based on a given search trail. The model utilizes a labeled set of training data, and an unlabeled set of training data. The labeled set of training data includes one or more search trails, or sequences of user actions, which are labeled in accordance with whether the respective search goals are achieved. The label for a given search trail may be provided by a corresponding user that conducted the search. The unlabeled set of training data includes one or more search trails, which are not labeled in accordance with whether the respective search goals are achieved.

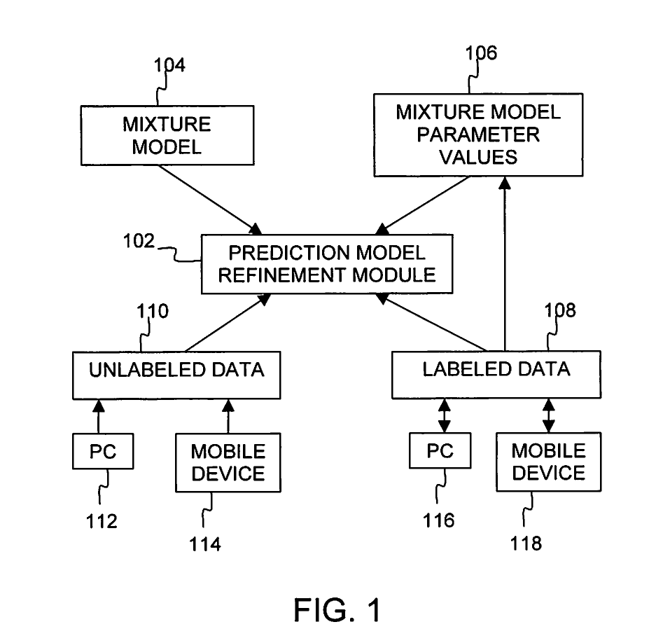

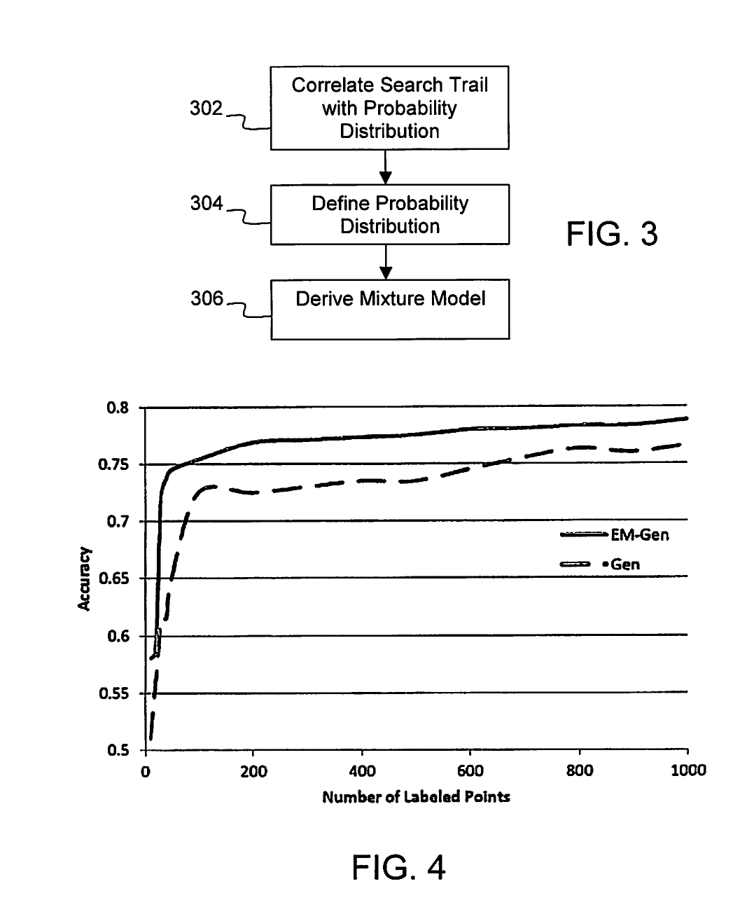

Referring initially to FIG. 1, a diagram illustrates a system for prediction model generation and refinement. A prediction model refinement module 102 receives a mixture model 104. The derivation of the mixture model 104 is described in detail with reference to FIG. 3. However, the mixture model 104 may also be predefined. When the mixture model 104 is predefined, it may be stored with or transmitted to the prediction model refinement module 102.

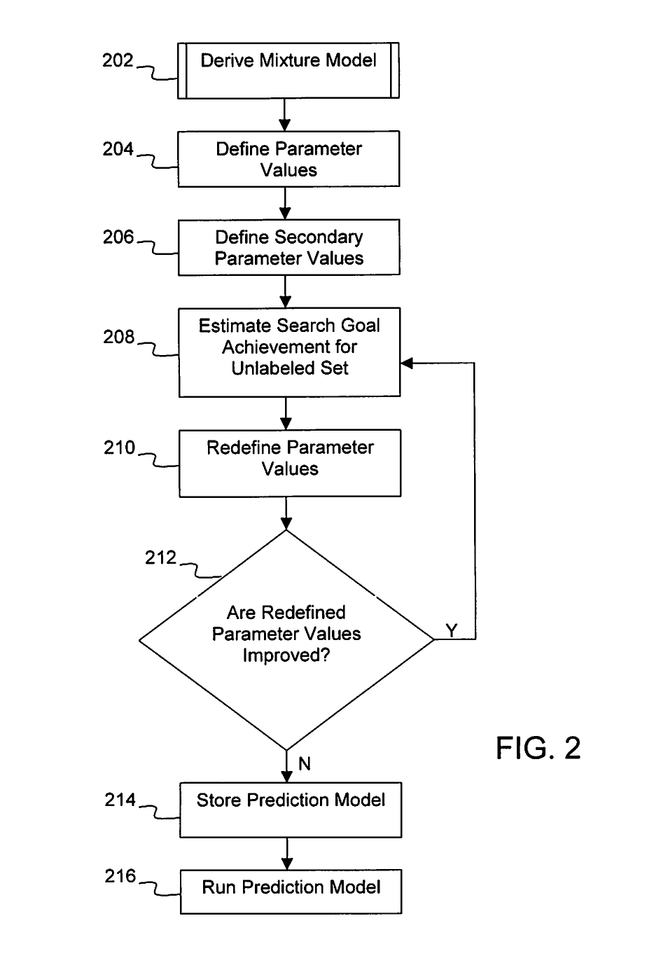

The prediction model refinement module 102 also receives mixture model parameter values 106. The mixture model parameter values 106 may be predefined and stored with or transmitted to the prediction model refinement module 102. The mixture module parameter values 106 may also be estimated in accordance with labeled data 108, as described in detail with reference to steps 204 and 206 of FIG. 2.

The labeled data 108 is also provided to the prediction model refinement module 102, along with unlabeled data 110. The prediction model refinement module 102 uses the mixture model 104, the mixture model parameter values 106, the labeled data 108 and the unlabeled data 110 to generate and refine a prediction model for determining the effectiveness of a search engine in providing a user with a desired search goal, as described in detail with reference to FIG. 2.

The unlabeled data 110 is used to train, or refine, the prediction model, and includes one or more search trails, which are not labeled in accordance with whether the respective search goals are achieved, as described above. The search trails are gathered from previous searches performed on a Personal Computer (PC) 112 or a mobile device 114, for example.

The labeled data 108 is also used to train, or refine, the prediction model, and includes one or more search trails, which are labeled in accordance with whether the respective search goals are achieved, as described above. The search trails are gathered from previous searches performed on a PC 116 and a mobile device 118. In order for the data to be labeled, input is required from users that conducted the searches. The PC 116 and the mobile device 118 may be solicited for information regarding labels for the search trails, before the respective labels are provided from the PC 116 and the mobile device 118.

Referring now to FIG. 2, a flow diagram illustrates a prediction model refinement methodology. The prediction model is used as a diagnostic tool to predict effectiveness of the search engine in achieving a given search goal corresponding to a given search trail. The methodology begins at step 202, in which a mixture model is derived. A mixture model corresponds to a mixture distribution that represents a probability distribution of observations in an overall population of data. Mixture models are used to make statistical inferences about properties of sub-populations given only observations on a pooled population, without population identity information. Specifically, according to an embodiment of the present invention, the mixture model correlates a given search trail to search goal achievement and pairs of user actions in the given search trail. Prior to continuing the description of FIG. 2, it is beneficial to further describe the derivation of the mixture model as provided in detail below, with respect FIG. 3.

Referring to FIG. 3, a flow diagram illustrates a mixture model derivation methodology. The methodology begins at step 302, in which a given search trail is correlated with a probability distribution defined by success and failure parameters of the mixture model. The description of FIG. 3 relates to a theoretical derivation of a mathematical model and does not relate to any specific search or search trail.

The parameters, θ, of the mixture model are defined in accordance with a set of search goal achievement classes C={cₛ,c_{f}}, where cₛ corresponds to a class indicating success in achieving a given search goal and c_{f} corresponds to a class indicating failure in achieving a given search goal. A given search trail, xᵢ, is defined in accordance with a success or a failure mixture model parameter, which correspond to class probabilities, P(cₛ|θ) and P(c_{f}|θ). User actions in the search trail are then defined using the selected mixture model parameter. Specifically, every search trail xᵢ is defined according to a probability distribution, P(xᵢ|c,θ), which is defined by the success and failure parameters of the mixture model. Therefore, the probability of generating a given search trail xᵢ is the sum of the probability distribution over the success and failure mixture model parameters, as shown in Equation (1) below. In this step, a distribution that models user behavior is defined. The generation probability is the probability that a set of particular actions (i.e., a search trail) is generated from the model that simulates user behavior.

$$P ( {x}_{i} \vert θ ) = {\sum }_{c ∈ [ {c}_{s} , {c}_{f} ]} P ( c \vert θ ) P ( {x}_{i} \vert c ; θ ) \qquad ( 1 )$$

It is then predicted whether a goal has been achieved or not based on user actions. Specifically, In step 304, the probability distribution, P(xᵢ|c,θ), of Equation (1) is defined in accordance with a dependency between user actions. This definition is used to derive the mixture model utilized in accordance with embodiments of the present invention.

Every search trail xᵢ consists of a set of user actions. In defining a search trail, a mixture model parameter and a length |xᵢ| of the search trail are selected. The length of the search trail is the number of user actions in the search trail. It is assumed herein that the length of the search trail is not an indicator of success in achieving a search goal. For every user action, a next user action is defined based on mixture distributions. It is assumed herein that every user action, after the first user action, is only dependent on the previous user action. Assuming every search trail includes a set of actions: x=a₁, a₂, . . . , aₙ}, the probability distribution can be written as shown in Equation (2) below.

$$P ( x \vert c , θ ) = ∝ {\prod }_{j = 1}^{n} P ( {a}_{j} \vert {a}_{j - 1} ; c ; θ ) \qquad ( 2 )$$

The model of Equation (2) obeys the Markovian assumption that user actions are dependent on a previous user action and independent of all other user actions. Specifically, transitions between user actions are conditionally independent. Accordingly, a set of parameters θ_{a,a′,c}=P(a′|a,c,θ) are defined for every pair of consecutive user actions a and a′, and every class c. Additionally, two more parameters θ_{cs} and θ_{cf} are defined that correspond to class probabilities P(cₛ|θ) and P(c_{f}|θ).

In step 306, the mixture model of Equation (1) is derived in accordance with the probability distribution defined in Equation (2). Specifically, the definition of the probability distribution shown in Equation (2) is substituted in for the probability distribution of Equation (1). Thus, the probability of generating a given search trail x is estimated based on search goal achievement and pairs of user actions in the search trail, as shown in Equation (3) below.

$$P ( x \vert θ ) ∝ {\sum }_{c ∈ [ {c}_{s} , {c}_{f} ]} P ( c \vert θ ) {\prod }_{j = 1}^{n} P ( {a}_{j} \vert {a}_{j - 1} ; c ; θ ) \qquad ( 3 )$$

In an alternate embodiment of the present invention, the mixture model is predefined and does not need to be generated in accordance with the steps of FIG. 3.

Referring back to FIG. 2, after the mixture model is acquired in step 202, values for parameters of the mixture model are defined based on a labeled set of one or more search trails, in step 204. The search trails in the labeled set are labeled in accordance with whether respective search goals are achieved.

More specifically, with respect to step 204, estimated values θ′ of the mixture model parameters, θ′_{a,a′,c}=P(a′|a,c,θ′), used in the mixture model of Equation (3), are computed. In order to estimate a value for these parameters, Maximum A Posteriori (MAP) estimates with Dirichlet priors are used. More specifically, Dirichlet distribution may be used as a prior for smoothing the MAP estimates. Thus, the values for the parameters, θ′_{a,a′,c}, specifically relating to user action transitions in the search trail, are estimated as set forth in Equation (4) below.

$${\hat{θ}}_{ai , aj , c} ≡ P ( {a}_{i} \vert {a}_{i - 1} ; c ; \hat{θ} ) = \frac{1 + {N}_{ai , aj , c}}{\vert A \vert + {N}_{ai , c}} \qquad ( 4 )$$

N_{ai,aj,c} is an empirical count of transitions from user actions aᵢ to aⱼ in search trails in class c, N_{ai,c} is an empirical count of the user action a, in the same search trails, and |A| is the total number of user actions.

In step 206, secondary values for additional parameters of the mixture model are defined based on the labeled set of one or more search trails. Specifically, values for parameters of class probabilities, θ′_{cs} and θ′_{cf}, used in the mixture model of Equation (3), are estimated as set forth in Equation (5) below.

$${\hat{θ}}_{c} ≡ P ( c \vert \hat{θ} ) = \frac{1 + {N}_{c}}{2 + N} \qquad ( 5 )$$

N_{c} is an empirical count of search trails in class c, and N is an empirical count of all search trails in the training data.

In accordance with alternate embodiments of the present invention, the initial values of the parameters relating to one or more of user action transitions, θ′_{aa′,c}, and/or class probabilities, θ′_{cs} and θ′_{cf,}, may be known. More specifically, the initial values of the parameters would not need to be estimated in steps 204 and/or 206, if they have been previously initialized based on an expert's intuition. Accordingly, if the parameter values are not known, the methodology of FIG. 1 would proceed from step 202-208. However, if the values for the parameters, θ′_{a,a′,c} are known, the methodology of FIG. 2 would jump from step 202 to step 206, skipping step 204. Similarly, if the values for the parameters θ′_{cs} and θ′_{cf}, are known, the methodology of FIG. 2 jump from step 204 to step 208, skipping step 106. Additionally, if the values for the parameters of θ′_{a,a′,c}, θ′_{cs} and θ′_{cf} 5are known, the methodology of FIG. 2 would jump from step 202 to step 208, skipping steps 204 and 206.

Due to the high cost of obtaining labeled data for training prediction models, and the wide availability of unlabeled data, the prediction model of embodiments of the present invention utilizes unlabeled data in learning to predict effectiveness of a search engine in achieving a goal of a search. In an embodiment of the present invention, in which parameters are not known initially, such that the method of FIG. 2 proceeds from steps 202-208, both labeled data and unlabeled data are used to train the prediction model. Model parameters θ′ are estimated using MAP estimations in steps 204 and 206. However, a MAP estimation procedure cannot be utilized for unlabeled data. Instead, an Expectation Maximization (EM) framework is used for the unlabeled data.

Embodiments of the present invention utilize an iterative algorithm to find the MAP estimates of the model parameters using unlabeled data. The iterative algorithm has two main steps: an Expectation step and a Maximization step. The Expectation step of the algorithm computes an estimate of missing values for the unlabeled data. Specifically, with respect to embodiments of the present invention, the Expectation step computes a search goal achievement class membership distribution for the unlabeled data. Thus, in step 208, it is estimated whether respective search goals are achieved for each of one or more search trails in the unlabeled set, based on search goal classifiers of the labeled set. More specifically, it is estimated whether a search goal is achieved for a given search trail in the unlabeled set, based on the success and failure search goal labels of the search trails in the labeled set.

In step 208, given the parameter values of step 204 and the secondary parameter values of step 206, a conditional probability distribution, with respect to search goal success and failure, is derived to classify a given search trail in the unlabeled set as a success or a failure in achieving a corresponding search goal. Specifically, the conditional probability distribution is derived using P(x|c,θ) of Equation (2), P(x|θ) of Equation (3), and P(c|θ) of Equation (5), as shown in Equation (6) below.

$$P ( c \vert {x}_{i} , \hat{θ} ) = \frac{P ( c \vert \hat{θ} ) P ( {x}_{i} \vert c ; \hat{θ} )}{P ( {x}_{i} \vert \hat{θ} )} \qquad ( 6 )$$

Therefore, classification of the given search trails is able to be performed in accordance with Equation (7) below, in which the PRED function predicts the success or failure of a search goal based on the greater of the conditional probability of success and the conditional probability of failure.

PRED(xᵢ)=arg max_{c∈(c}_{ₛ}_{,c}_{_{f}}_{}}P(c|xᵢ, \hat{θ}) (7)

The Maximization step redefines the values of the parameters, θ′_{a,a′,c}, relating to user action transitions by maximizing the likelihood of the parameters using the previously computed expectations. Accordingly, in step 210, the previously defined values for θ′_{a,a′,c} are redefined in accordance with the new estimates for the unlabeled data defined in step 208, and, if applicable, the labeled data used in step 204.

Therefore, the unlabeled data is incorporated into the training of the prediction model by redefining the parameters relating to user action transitions. Specifically, Equation (4) is modified into Equation (8) as set forth below.

$${\hat{θ}}_{ai , aj , c} ≡ P ( {a}_{i} \vert {a}_{i} - 1 ; c ; \hat{θ} ) = \frac{1 + {\sum }_{{x}_{i} ∈ X} δ ( {x}_{i} , c ) N ( {x}_{i} , a , {a}^{′} )}{\vert A \vert + {\sum }_{{x}_{i} ∈ X} δ ( {x}_{i} , c ) N ( {x}_{i} , a )} \qquad ( 8 )$$

X is the set of training data, N(xᵢ,a,a′) is the number of transitions from user action a to a′ in search trail xᵢ, and N(xᵢ;a) is the number of occurrences of user action a in search trail xᵢ. For the labeled data, δ(xᵢ, c) is 1 if xᵢ is in class c, and 0 otherwise. For the unlabeled data, δ(xᵢ,c) is the class membership probabilities with respect to search goal achievement calculated in step 208.

In step 212, it is determined whether the redefined values are an improvement over the parameter values defined prior to redefining. Specifically, when the redefined values are improved, they will have changed from the previous iteration of the values by an amount that is greater than a predefined threshold. When the redefined values change by an amount that is less than the predefined threshold, the values are no longer considered to be improved. Alternate embodiments of the present invention may present any number of measures for determining whether a value has improved in comparison to a value of a previous iteration.

If it is determined that the redefined values are improved, the methodology returns to the step 208. Thus, in a subsequent iteration, it is estimated whether respective search goals are achieved for each of one or more search trails in the unlabeled set using Equation (6) and the redefined values of step 210 from the previous iteration. In step 210, the values of parameters relating to user action transitions are again redefined in accordance with the new estimates of step 208.

Accordingly, the methodology of FIG. 2 may proceed from step 202 through step 212 without any additional iterations, or the methodology may continuously iterate through steps 208-212 as long as the redefined values of step 210 continue to improve.

If, in step 212, it is determined that the redefined values are not improved, the prediction model of Equations (6) and (7) is stored with the redefined values of step 210 and the secondary values of step 206, in step 214.

In step 216, the stored prediction model is run for a given search trail to predict whether a corresponding search goal was achieved for the given search trail, terminating the methodology of FIG. 2.

In an embodiment of the present invention, the given search trail may be a stored and previously unlabeled search trail provided by system developers. In an alternate embodiment of the present invention, the given search trail may be provided to the prediction model in real-time by a user of the search engine.

Referring now to FIG. 4, a graph compares prediction model effectiveness. Specifically, FIG. 4 charts a number of pieces of labeled data used in training versus an accuracy of a prediction model. The prediction model accuracy quantifies the prediction model's ability to correctly predict whether a given search trail achieves a corresponding search goal. More specifically, FIG. 4 compares a prediction model, Gen, that uses only labeled data to a prediction model, EM-Gen, which is provided in accordance with embodiments of the present invention, and which uses both labeled and unlabeled data in training. The prediction model, EM-Gen, which is provided in accordance with the embodiments of the present invention, is shown to be more accurate than the prediction model, Gen, which was trained using only labeled data. Specifically, a prediction model using both labeled and unlabeled data, EM-Gen, achieves an accuracy of 75 percent when trained with less than 200 pieces of labeled data, while a prediction model trained using only labeled data, Gen, achieves this accuracy only when trained with more than 600 pieces of labeled data. Thus, the embodiments of the present invention provide a more accurate prediction model that uses less labeled data.

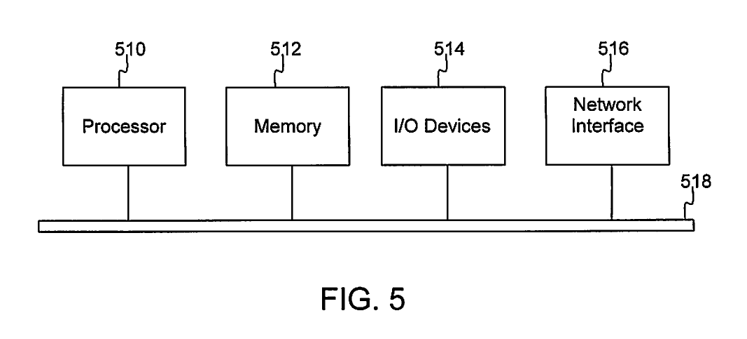

Referring now to FIG. 5, a block diagram illustrates an illustrative hardware implementation of a computing system. Specifically, one or more components/methodologies described in the context of FIGS. 1-3 may be implemented in accordance with the hardware implementation of FIG. 5. As shown, the computer system may be implemented in accordance with a processor 510, a memory 512, Input/Output (I/O) devices 514, and a network interface 516, coupled via a computer bus 518 or alternate connection arrangement, such as a wireless network.

It is to be appreciated that the term “processor” as used herein is intended to include any processing device, such as, for example, one that includes a Central Processing Unit (CPU) and/or other processing circuitry. It is also to be understood that the term “processor” may refer to more than one processing device and that various elements associated with a processing device may be shared by other processing devices.

In addition, the phrase “I/O devices” as used herein is intended to include; for example, one or more input devices for entering, for example, information associated with a search trail, a search query and query result selections, into the processing unit, and/or one or more output devices for outputting, for example, a search goal classification for a given search trail, and a query result page, associated with the processing unit.

Still further, the phrase “network interface” as used herein is intended to include, for example, one or more transceivers to permit the computer system to communicate with another computer system via an appropriate communications protocol. This may provide access to one or more computer systems that provide labeled and unlabeled data and information regarding search results.

The term “memory” is an example of a computer readable storage medium. By way of example, and not limitation, computer readable storage media may include volatile and non-volatile, removable and non-removable media implemented in any method or technology for storage of information such as computer readable instructions, data structures, program modules, or other data. Computer readable storage media includes, but is not limited to, Random Access Memory (RAM), Read Only Memory (ROM), Electronically Erasable Programmable ROM (EEPROM), flash memory, or other memory technology, Compact Disc ROM (CD-ROM), Digital Versatile Discs (DVD) or other optical storage devices, or any other medium which can be used to store the desired information and which can be accessed by the computing system. The computer readable storage medium may have computer-readable instructions for generating and executing the prediction model.

For example, software components or code for performing the methodologies described herein may be stored in one or more of the associated memory devices (e.g., ROM, fixed or removable memory) and when ready to be utilized, loaded in part or in whole (e.g., into RAM) and executed by a CPU.

Accordingly, the embodiments of the present invention may be utilized to train a search goal success prediction model using labeled and unlabeled data, which results in improved accuracy. The resulting search goal success prediction model may be utilized to track search goal success and to find patterns of search goal failure, which can be utilized by system developers in refining the search engine. Further, the resulting search goal success prediction model may be utilized in providing a user of a search engine with statistics relating to effectiveness of the search engine for that user. These statistics may provide a basis for providing suggestions to the user on how to improve entered search queries or for modifying the search engine for the user, in order to improve effectiveness of the search engine on an individual basis.

While the invention has been shown and described with reference to certain embodiments thereof, it will be understood by those skilled in the art that the invention is not limited to these embodiments, and that various changes in form and detail may be made therein without departing from the spirit and scope of the invention as defined by the appended claims and their equivalents.

What is claimed is:

1. A computer-implemented method for refining a prediction model for determining effectiveness of a search engine, the method comprising the steps of:
deriving a mixture model in accordance with a sequence of user actions and search goal achievement, with respect to the search engine;
estimating whether respective search goals are achieved for each of one or more sequences of user actions in a first set using the prediction model, which is based on the mixture model and values for parameters of the mixture model, wherein the one or more sequences of user actions in the first set are not labeled in accordance with whether the respective search goals are achieved;
redefining the values of the parameters of the mixture model based at least on search goal achievement estimates of the first set; and
storing the prediction model in accordance with the mixture model and the redefined values.

2. The computer-implemented method of claim 1, further comprising:
determining whether the redefined values are an improvement over the values prior to a latest redefining; and
repeating the estimating, redefining and determining steps for refinement of the prediction model, when the redefined values are improved;
wherein the prediction model is stored with the redefined values, when the redefined values are not improved.

3. The computer-implemented method of claim 2, wherein the redefined values are improved when changed by an amount greater than a predetermined threshold when compared to the values prior to the latest redefining.

4. The computer-implemented method of claim 1, further comprising defining the values of the parameters of the mixture model for use in the estimating step based on a second set of one or more sequences of user actions that are labeled in accordance with whether respective search goals are achieved.

5. The computer-implemented method of claim 4, wherein the values are redefined based on the search goal achievement estimates of the first set and based on the second set of one or more sequences of user actions.

6. The computer-implemented method of claim 4, wherein the parameters of the mixture model relate to transitions between the user actions.

7. The computer-implemented method of claim 6, further comprising defining secondary values for additional parameters of the mixture model based on the second set of one or more sequences of user actions, wherein the additional parameters relate to probabilities of success and failure with respect to search goal achievement.

8. The computer-implemented method of claim 7, further comprising generating the prediction model using the mixture model, a probability distribution defined in accordance with dependency between the user actions, and the defined secondary values for the additional parameters.

9. The computer-implemented method of claim 7, further comprising running the prediction model for a given sequence of user actions to predict whether a corresponding search goal was achieved for the given sequence of user actions in accordance with the stored redefined values.

10. The computer-implemented method of claim 1, wherein the sequence of user actions comprise at least one of a query submission, a query rewrite, a query result selection, a search engine sponsor result selection, and a time between consecutive user actions.

11. The computer-implemented method of claim 1, wherein acquiring the mixture model comprises:
correlating the sequence of user actions with a probability distribution defined by success and failure parameters of the mixture model; and
defining the probability distribution assuming every action, in the sequence of user actions after a first user action, is dependent on a previous user action in the sequence of user actions and independent of all other user actions in the sequence of user actions; and
derive the mixture model in accordance with the probability distribution.

12. The computer-implemented method of claim 11, wherein the mixture model uses a length of the sequence of the user actions.

13. A computer-implemented method for refining a prediction model for determining effectiveness of a search engine, the method comprising the steps of:
estimating whether respective search goals are achieved for each of one or more sequences of user actions in a first set using the prediction model, which is based on a mixture model and values for parameters of the mixture model, wherein the one or more sequences of user actions in the first set are not labeled in accordance with whether the respective search goals are achieved;
redefine the values of the parameters of the mixture model based at least on search goal achievement estimates of the first set;
determining whether the redefined values are an improvement over the values prior to a latest redefining;
repeating the estimating, redefining and determining steps for refinement of the prediction model, when the redefined values are improved;
storing the prediction model in accordance with the mixture model and the redefined values when the redefined values are not improved.

14. The computer-implemented method of claim 13, wherein the redefined values are improved when changed by an amount greater than a predetermined threshold when compared to the values prior to the latest redefining.

15. The computer-implemented method of claim 13, further comprising defining the values of the parameters of the mixture model for use in the estimating step based on a second set of one or more sequences of user actions that are labeled in accordance with whether respective search goals are achieved, wherein the parameters of the mixture model relate to transitions between the user actions.

16. The computer-implemented method of claim 15, wherein the values are redefined based on the search goal achievement estimates of the first set and based on the second set of one or more sequences of user actions.

17. The computer-implemented method of claim 15, further comprising defining secondary values for additional parameters of the mixture model based on the second set of one or more sequences of user actions, wherein the additional parameters relate to probabilities of success and failure with respect to search goal achievement.

18. The computer-implemented method of claim 17, further comprising generating the prediction model using the mixture model, a probability distribution defined in accordance with dependency between the user actions, and the defined secondary values for the additional parameters.

19. The computer-implemented method of claim 18, further comprising running the prediction model for a given sequence of user actions to predict whether a corresponding search goal was achieved for the given sequence of user actions in accordance with the stored redefined values.

20. An apparatus for refining a prediction model for determining effectiveness of a search engine, comprising:
at least one processor operative to: (i) derive a mixture model in accordance with a sequence of user actions and search goal achievement, with respect to the search engine; (ii) estimate whether respective search goals are achieved for each of one or more sequences of user actions in a first set using the prediction model, which is based on the mixture model and values for parameters of the mixture model, wherein the one or more sequences of user actions in the first set are not labeled in accordance with whether the respective search goals are achieved; and (iii) redefine the values of the parameters of the mixture model based at least on search goal achievement estimates of the first set;
a memory, coupled to the at least one processor, for storing the prediction model in accordance with the mixture model and the redefined values; and
a network interface coupled to both the processor and the memory that provides the at least one processor with access to the one or more sequences of user actions in the first set.
